(19) United States
(12) Patent Application Publication
(10) Pub. No.: US 2019/0338675 A1
(43) Pub. Date: Nov. 7, 2019

(54) Variable Stiffness Structural Member

(71) Applicant: General Electric Company, Schenectady, NY (US)

(72) Inventor: Richard Schmidt, Loveland, OH (US)

(21) Appl. No.: 15/967,885

(22) Filed: May 1, 2018

(51) Int. Cl. F01D 25/24; F01D 25/16; F01D 15/12

(52) U.S. Cl. CPC F01D 25/24; F05D 2220/32; F01D 15/12; F01D 25/162

(57) ABSTRACT

A static support structure including a plurality of members extended along a lengthwise direction coupled to a support body. Each of the plurality of members is disposed in adjacent arrangement along a load direction. Each adjacent pair of members defines a gap therebetween. The plurality of members provides a nonlinear force versus deflection of the static support structure.

### FIELD

The present subject matter relates generally to variable stiffness static members for mechanical structures.

### BACKGROUND

Mechanical structures, including static casings surrounding rotary structures for turbine engines or ground, sea, or air vehicles generally include structural members defining a single linear stiffness, or load versus deflection, for each load member. However, load changes or deflections may define linear behavior based on operating conditions of the mechanical structure to which the structural member is defined. As such, known structural members may define limited ranges of operability relative to load or deflection behaviors of the mechanical structure to which the structural member is attached. Therefore, there is a need for improved stiffness properties for structural members for mechanical structures.

### BRIEF DESCRIPTION

Aspects and advantages of the invention will be set forth in part in the following description, or may be obvious from the description, or may be learned through practice of the invention.

An aspect of the present disclosure is directed to a static support structure. The static support structure includes a plurality of members extended along a lengthwise direction coupled to a support body. Each of the plurality of members is disposed in adjacent arrangement along a load direction. Each adjacent pair of members defines a gap therebetween. The plurality of members provides a nonlinear force versus deflection of the static support structure.

In one embodiment, at least one member defines a primary member defining an initial stiffness. At least one member defines one or more secondary stiffnesses less than or greater than the initial stiffness.

In various embodiments, at least one member defines a primary member defining a nominal dimension. At least one member defines one or more secondary members defining one or more secondary dimensions different from the nominal dimension. In one embodiment, the nominal dimension is defined along a depth, wherein the depth corresponds to the load direction.

In various embodiments, the plurality of members define a uni-nonlinear arrangement. In one embodiment, the plurality of members are disposed in adjacent arrangement in descending dimensional order along a depth of the static support structure. In another embodiment, the plurality of members are disposed in asymmetric arrangement along a depth of the static support structure.

In still various embodiments, the plurality of members defines a bi-nonlinear arrangement. In one embodiment, one or more of the secondary members are disposed between a pair or more of primary members along a depth of the static support structure. In another embodiment, one or more of the primary members are disposed between a pair or more of secondary members along a depth of the static support structure.

In one embodiment, the plurality of members each extend at least partially circumferentially around an axial centerline axis. The plurality of members are each disposed in radial arrangement from the axial centerline axis.

In another embodiment, the static support structure further includes a viscous material disposed at least partially within the gap defined between a pair of the plurality of members.

In one embodiment, the gap defines a substantially constant cross sectional area along the lengthwise direction, a traverse direction, a depth, or combinations thereof.

In another embodiment, the gap defines a substantially variable cross sectional area along the lengthwise direction, a traverse direction, a depth, or combinations thereof.

Another aspect of the present disclosure is directed to a mechanical system including a static support structure. The static support structure includes a plurality of members extended along a lengthwise direction coupled to a support body. Each of the plurality of members is disposed in adjacent arrangement along a load direction. Each adjacent pair of members defines a gap therebetween. The plurality of members provides a nonlinear force versus deflection of the static support structure.

In one embodiment, at least one member defines a primary member defining an initial stiffness, and further wherein at least one member defines a secondary member defining one or more secondary stiffnesses less than or greater than the initial stiffness.

In another embodiment, the static support structure further includes a load member coupled to one or more of the plurality of members of the static support structure.

In yet another embodiment, at least one member of the static support structure defines a primary member defining a nominal dimension. At least one member defines one or more secondary members defining a secondary dimension different than the nominal dimension.

In various embodiments, the static support structure at least partially defines a bearing assembly, a gear assembly, or casing.

In one embodiment, the mechanical system defines a turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIGS. 1A-1H are lengthwise views of exemplary embodiments of a plurality of members of a static support structure according to aspects of the present disclosure;

FIGS. 2A-2B are end views of exemplary embodiments of a plurality of members of a static support structure according to aspects of the present disclosure;

FIGS. 3A-3B are end views of exemplary embodiments of a plurality of members of a static support structure according to aspects of the present disclosure;

FIGS. 4A-4B are end views of exemplary embodiments of a plurality of members of a static support structure according to aspects of the present disclosure;

FIG. 5 is a radial view of an exemplary embodiment of a plurality of members of a static support structure according to an aspect of the present disclosure;

FIGS. 6A-6D are exemplary force versus deflection graphs of embodiments of the static support structure according to aspects of the present disclosure;

FIG. 7 is an exemplary embodiment of a static support structure including an embodiment of the plurality of members according to an aspect of the present disclosure; and

FIGS. 8-9 are exemplary embodiments of mechanical systems to which exemplary embodiments of the static support structure may be included; and

FIG. 10 is an exemplary embodiment of a portion of a mechanical system including a reduction gear assembly to which various embodiments of the static support structure generally provided in FIGS. 1-9 may be included.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Approximations recited herein may include margins based on one more measurement devices as used in the art, such as, but not limited to, a percentage of a full scale measurement range of a measurement device or sensor. Alternatively, approximations recited herein may include margins of 10% of an upper limit value greater than the upper limit value or 10% of a lower limit value less than the lower limit value.

Embodiments of variable stiffness static support structures shown and described herein may provide improved stiffness properties for structural members and mechanical systems to which they may be included. The embodiments of the static support structures generally shown and described herein include gaps between two or more structures to selectively close or open based on deflections of a plurality of members due to various applied loads. As the gap closes or opens, the static support structure defines two or more stiffness slopes as to improve the stiffness properties of the mechanical system. Such improved stiffness properties may improve mechanical system responses due to undesired loading conditions or vibratory modes via the variable stiffness structure relative to desired deflection thresholds.

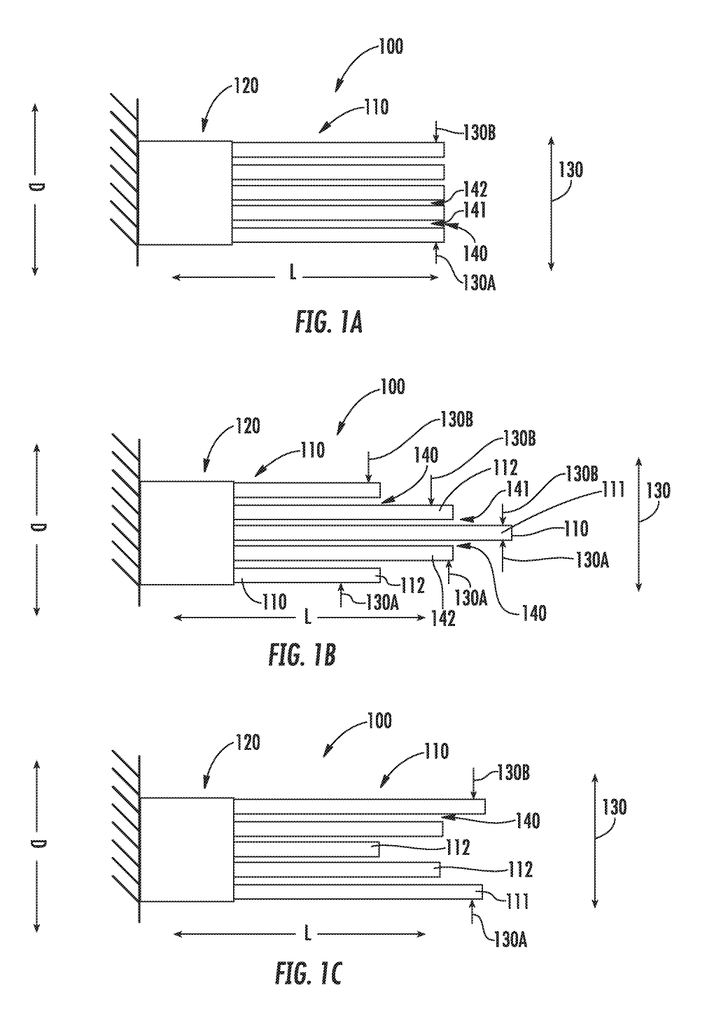

Referring now to the drawings, FIG. 1A is a side cross sectional view of an exemplary embodiment of a static support structure 100. The static support structure 100 includes a plurality of members 110 extended along a lengthwise direction L. The plurality of members 110 are each coupled to a support body 120. In various embodiments, the support body 120 may generally define a grounding structure for the plurality of members 110. For example, the support body 120 may define a frame, casing, mount, pylon, beam, or another fixed structure to which the plurality of members 110 may attach. The plurality of members 110 are each disposed in adjacent arrangement and define a gap 140 between two or more of the plurality of members 110. For example, the gap 140 is defined between a pair or more members of the plurality of members 110. In various embodiments, the plurality of members 110 is disposed in adjacent arrangement along a depth D of the static support structure 100. For example, the depth D may substantially correspond to a load direction 130 applied to the plurality of members 110, and its opposite direction.

In various embodiments, the static support structure 100 may define a cantilevered or partially cantilevered structure. In still various embodiments, such as generally provided in regard to FIG. 1H, the static support structure 100 may further include a plurality of the support body 120 coupled to one or more of the plurality of members 110 at opposite ends. As such, at least one member may be fixed at opposite ends via the support body 120. Still further, one or more other members may be cantilevered from one or another of the support body 120.

Referring now to FIGS. 1B-1H, side cross sectional views of further exemplary embodiments of the static support structure 100 are generally provided. In the embodiments generally provided in regard to FIGS. 1B-1H, the plurality of members 110 defines at least one member as a primary member 111 defining an initial stiffness. The plurality of members 110 further defines at least one member as a secondary member 112 defining one or more secondary stiffnesses greater than or less than the initial stiffness of the primary member 111. The plurality of members 110 are each disposed in adjacent arrangement and define a gap 140 between two or more of the plurality of members 110. For example, the gap 140 may be defined between the primary member 111 and the secondary member 112 of the plurality of members 110. The gap 140 may further be defined between each of the secondary members 112.

In various embodiments, the gap 140 may define a substantially constant cross sectional area. For example, regarding FIGS. 1A-1C, the gap 140 may define a substantially constant cross sectional area or volume along the lengthwise direction L. As such, a distance between a pair of the plurality of members 110 (e.g., a distance along the depth D between the primary member 111 and the adjacent secondary member 112, or a distance between two adjacent secondary members 112, etc.) may be substantially constant relative to locations along the lengthwise direction L during a substantially unloaded condition. For example, the substantially unloaded condition may generally define loads applied to the static support structure 100 that are less than a threshold necessary to deform or deflect one or more of the plurality of members 110.

In other embodiments, such as in regard to FIG. 1D, the gap 140 may define a substantially variable cross sectional area or volume along the lengthwise direction L during substantially unloaded conditions. For example, the gap 140 may define a contour or curved profile such that the cross sectional area or distance between adjacent pairs of the plurality of members 110 varies along the lengthwise direction L. In one embodiment, the variable cross sectional area of the gap 140 at least partially conforming to a curvature of an adjacent member 110 when a load is applied to the adjacent member 110 along the load direction 130.

In another embodiment, such as generally shown in regard to FIG. 1D, the primary member 111 may define a substantially constant cross sectional area or volume along the lengthwise direction L and one or more of the adjacent secondary member 112 may define a substantially variable cross sectional area of volume along the lengthwise direction L such as to at least partially conform to a deformation or deflection of the primary member 111 at or above a threshold loading condition. For example, such as described above, the threshold loading condition may be a minimum loading onto the member 110 (e.g., the primary member 111) such as to deflect the member 110 along the load direction 130.

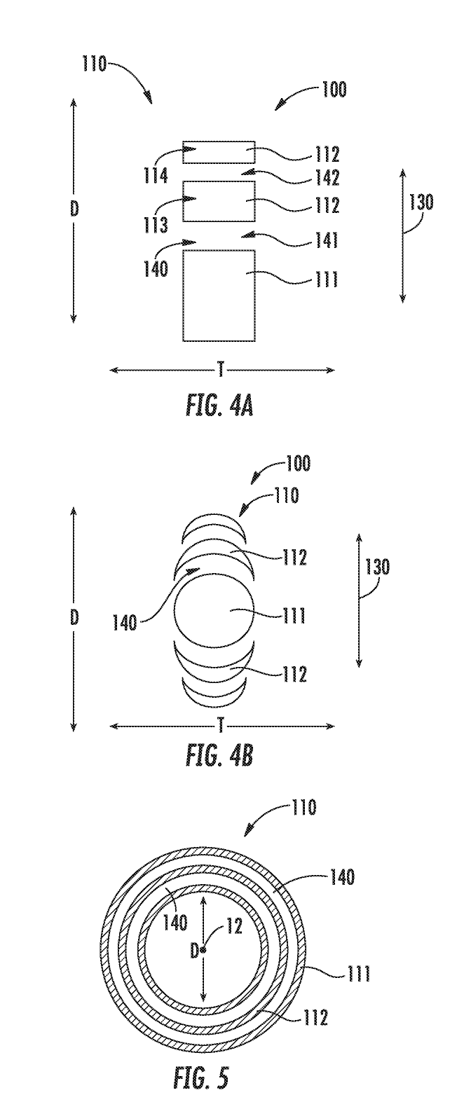

In still various embodiments, the gap 140 may define a substantially variable cross sectional area along a traverse direction T, a depth D, or both, during substantially unloaded conditions. For example, such as generally shown and described further below in regard to FIG. 4B, the gap 140 may define a contour or curved profile such that the cross sectional area or distance between adjacent pairs of the plurality of members 110 varies along the traverse direction T and/or the depth D. In one embodiment, the variable cross sectional area of the gap 140 at least partially conforming to a curvature of an adjacent member 110 when a load is applied to the adjacent member 110 along the load direction 130.

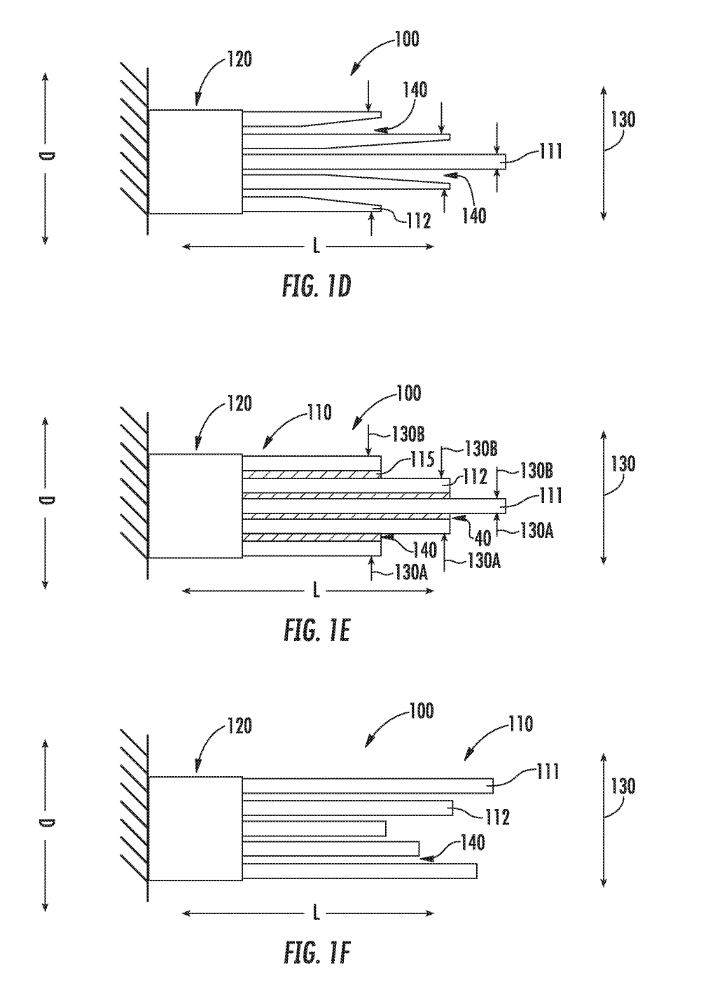

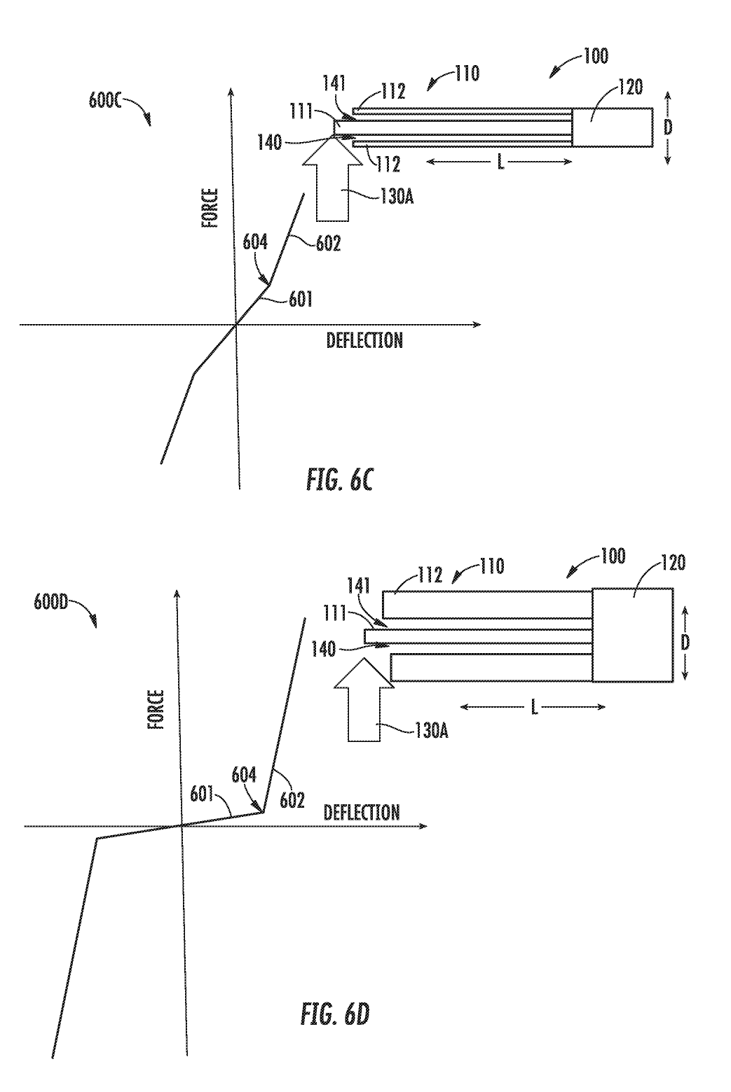

Referring back to FIGS. 1A-1H in conjunction with the cross sectional views provided in regard to FIGS. 2-5, the plurality of members 110 may further be disposed in adjacent arrangement along depth D of the static support structure 100. More specifically, the adjacent arrangement of the plurality of members 110 along the depth D may be along the load direction, such as shown schematically by arrows 130, 130A, and 130B. As such, the static support structure 100 including the plurality of members 110 in adjacent arrangement along the load direction 130 define a nonlinear load versus deflection, such as generally exemplified in graphs (e.g., graph 600A, 600B, 600C, 600D) provided in regard to FIGS. 6A-6D.

Referring to FIGS. 6A-6B, in conjunction with FIGS. 1-5, the plurality of members 110 in adjacent arrangement along the load direction 130 may define a plurality of different linear stiffnesses defined by the slope of the load or force versus deflection such as to define an overall nonlinear stiffness of the static support structure 100. For example, in regard to FIG. 1A, each member of the plurality of members 110 may define an initial stiffness (e.g., the plurality of members 110 may define a plurality of the primary member 111, such as shown and described in regard to FIGS. 1B-1H). The first stiffness may be exemplified such as shown and described in regard to FIG. 6A in regard to graph 600A via a first slope 601 of the load or force versus deflection graph 600A. Referring to FIG. 1A in conjunction with FIG. 6A, as the initial load 130A or load 130B contacts the member 110, the gap 140 defined between each pair of members 110 decreases to zero as the initially loaded member deflects onto the adjacent member. For example, a first gap 141 defined between the member 110 onto which the load is applied (e.g., load 130A) and the directly adjacent member 110 along the depth D is decreased toward zero as the load 130A increases. When the first gap 141 is zero, another adjacent pair of members 110 receives, at least in part, the load 130A applied to the adjacent members 110. A second gap 142 defined between the adjacent pair of members 110 relative to the first gap 141 decreases to zero as the load 130A is increased.

As another example, as the initial load 130A is applied and the first gap 141 decreases to zero, the static support structure 100 defines the first slope 601 such as shown in regard to graph 600A in FIG. 6A. When the first gap 141 is zero and the plurality of members 110 is reducing the second gap 142, the static support structure 100 defines the second slope 602 different from the first slope 601 such as shown in regard to graph 600A in FIG. 6A. In various embodiments, N quantity of gaps between N pairs of members 110 may be defined such as to define N slopes of N stiffnesses relative to the load or force versus deflection graph 600A.

In another embodiment, such as shown and described in regard to FIGS. 1B-1E, the primary member 111 defines an initial stiffness, such as exemplified in graphs 600A, 600B, 600C, 600D defined by the first slope 601 of the load or force versus deflection graph 600A, 600B, 600C, 600D. As deflection of the primary member 111 increases with the increasing initial load, the first gap 141 defined between the primary member 111 and the secondary member 112 decreases to zero. When the first gap 141 is zero and the primary member 111 deflects onto the secondary member 112 defining a stiffness less than or greater than the initial stiffness of the primary member 111, the static support structure 100 defines the second stiffness defined by the second slope 602 of the load versus deflection graph 600A, 600B, 600C, 600D (e.g., the combined stiffness of the initially loaded member and the subsequently loaded member(s)). As deflection of the primary member 111 and the secondary member 112 increases with the increasing load (e.g., load 130A or load 130B), the second gap 142 defined between an adjacent plurality of secondary members 112 and the primary member 111 decreases. Still further, as deflection of the primary member 111 and a plurality of the secondary member 112 increases with the increasing load, additional gaps defined between the adjacent plurality of secondary members 112 and the primary member 111 further decreases. With each additional secondary member 112 contacting one another as each gap 140 decreases to zero, the static support structure 100 defines Nth stiffnesses defined by an Nth slope 603 of the load versus deflection graph 600.

As loading increase or decreases, the static support structure 100 changes stiffness slopes at desired load thresholds, exemplified at 604. Each threshold 604 corresponds substantially to the closing of each gap 140 between each pair of members 110. For example, as previously described, the threshold 604 between the first slope 601 and the second slope 602 may substantially correspond to adjacent pairs of members 110 deflecting onto one another. For example, adjacent pairs of members 110 deflecting onto one another may include the primary member 111 deflecting onto the secondary member 112 such that the first gap 141 is zero. As another example, as previously described, the threshold 604 between the second slope 602 and the Nth slope 603 may substantially correspond to the primary member 111 and one or more of the secondary members 112 deflecting onto one or more of another of the secondary members 112 such that the first gap 141, the second gap 142, and a plurality of the gap 140 including the Nth gap are zero.

It should be appreciated that although the graphs 600A, 600B, 600C, 600D and the static support structure 100 are described in regard to the plurality of members 110 closing onto one another to define one or more of the gaps 140 as zero based on the deflection increasing to and above a desired threshold 604, the static support structure 100 is further operable such that the plurality of members 110 open or detach from one another to increase one or more of the gaps 140 greater than zero based on the deflection decreasing below a desired threshold 604. As such, it should be appreciated that the gaps 140 may open and close based at least on deflection of the plurality of members 110 of the static support structure 100 such that the operation is reversible (e.g., deflection or deformation is elastic).

Referring now to FIG. 6A, the graph 600A generally depicts a force or load versus deflection curve of the static support structure 100 defining a bi-nonlinear arrangement, such as further shown and described in regard to FIGS. 1A-1E, FIGS. 3A-3B, and FIG. 4B further below. For example, the graph 600A may define a nonlinear stiffness for the static structure 100, or a plurality of different linear stiffnesses (e.g., stiffness 601, 602, 603, etc.), along an opposite direction force or load and deflection. In various embodiments of the static support structure 100, such as generally shown and described in regard to FIGS. 1A-1E, the plurality of members 110 may be defined and arranged generally symmetrically along the depth D or load direction 130 such that the graph 600A is substantially equal and opposite along opposite load and deflection directions. For example, a total stiffness of the plurality of members 110 along a first load direction 130 is substantially equal in magnitude relative to a total stiffness of the plurality of members 110 along a second load direction 130 opposite of the first load direction 130.

In other embodiments, such as in regard to FIGS. 1F-1H, the static support structure 100 may define or arrange the plurality of members 110 asymmetrically along the depth D or load direction 130 such that the graph 600A defines a plurality of stiffnesses unequal relative to opposite load and deflection directions. For example, the plurality of members 110 may define a plurality of stiffnesses, dimensions, and/or materials arranged along a first load direction 130 different from another plurality of members 110 defining another plurality of stiffnesses, dimensions, and/or materials along a second load direction 130 opposite of the first load direction 130. As such, a total stiffness of the plurality of members 110 along a first load direction 130 is different in magnitude from a total stiffness of the plurality of members 110 along a second load direction 130 opposite of the first load direction 130.

Referring now to FIG. 6B, the graph 600B generally depicts a force or load versus deflection curve of the static support structure 100 defining a uni-nonlinear arrangement, such as further shown and described in regard to FIGS. 2A-2B, FIG. 4A, and further depicted at the exemplary embodiments of the static support structure 100 alongside FIG. 6B. For example, the graph 600B may define a nonlinear stiffness for the static structure 100, or a plurality of different linear stiffnesses (e.g., stiffness 601, 602, 603, etc.), along a first load direction 130A, such that the plurality of members 110 deflects along the first load direction 130A. In various embodiments of the static support structure 100, such as generally shown and described in regard to FIGS. 2A-2B, FIG. 4A, and FIG. 6B, the plurality of members 110 may be defined and arranged generally asymmetrically along the depth D or load direction 130 such that the graph 600B defines a nonlinear curve including a plurality of stiffnesses (e.g., slopes 601, 602, 603) and stiffness inflection points or thresholds 604 along the first load direction 130A, and a substantially linear curve including a single stiffness slope 605 along the second load direction 130B opposite of the first load direction 130A.

For example, when a load is applied to the primary member 111 along the first load direction 130A, a total stiffness of the static support structure 100 along the first load direction 130A is substantially defined by the plurality of members 110 engaged along the first load direction 130A (e.g., primary member 111 and one or more secondary members 112). As another example, when a load is applied to the primary member 111 along the second load direction 130B opposite of the first load direction 130A, a total stiffness of the static support structure 100 along the second load direction 130B is substantially defined by the primary member 111 as the secondary members 112 are substantially unloaded.

Referring now to FIG. 6C, another exemplary embodiment of the load or force versus deflection graph 600C is generally provided relative to another embodiment of the static support structure 100 provided such as shown in regard to FIG. 6C. In such an embodiment, the static support structure 100 may define the primary member 111 of the plurality of members 110 as a greater first stiffness than one or more of the second stiffness defined at one or more of the secondary members 112. As the initial load 130A is applied to the primary member 111, the primary member 111 defines the stiffness such as generally depicted in regard to slope 601. As the first gap 141 decreases until the load 130A deflects the primary member 111 onto the secondary member 112, such as corresponding to the threshold 604 in graph 600C, the static support structure 100 defines the stiffness such as depicted in regard to slope 602. In the embodiment generally shown in regard to graph 600C, the primary member 111 may define the first stiffness greater than the secondary member 112 such that the slope 601 defines relatively less deflection versus the change in load in contrast to the slope 602.

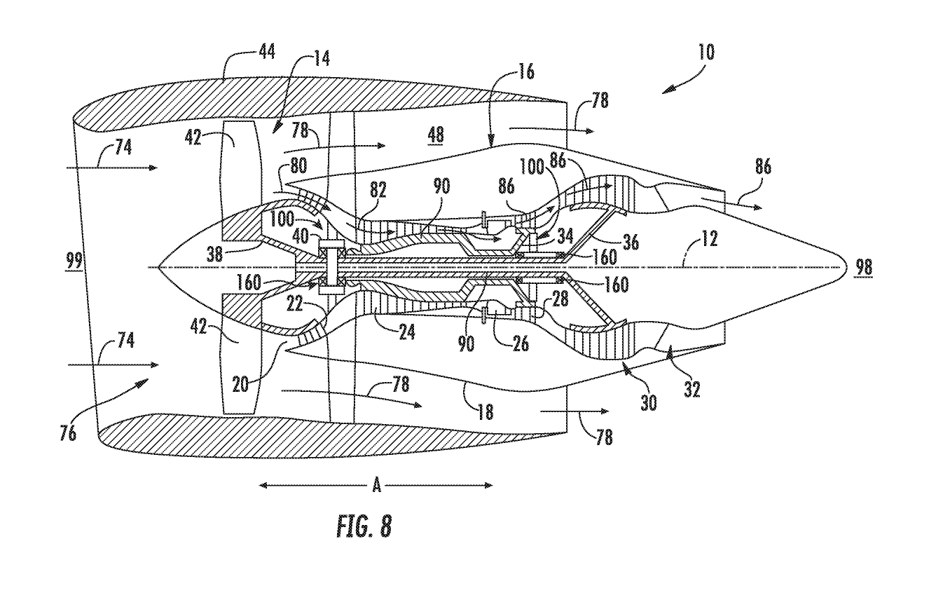

Referring now to FIG. 6D, yet another exemplary embodiment of the force versus deflection graph 600D is generally provided relative to another embodiment of the static support structure 100 provided such as shown in regard to FIG. 6D. In such an embodiment, the static support structure 100 may define the primary member 111 of the plurality of members 110 as a lesser first stiffness than one or more of the second stiffness defined at one or more of the secondary members 112. As the initial load 130A is applied to the primary member 111, the primary member 111 defines the stiffness such as generally depicted in regard to slope 601. As the first gap 141 decreases until the load 130A deflects the primary member 111 onto the secondary member 112, such as corresponding to the threshold 604 in graph 600D, the static support structure 100 defines the stiffness such as depicted in regard to slope 602. In the embodiment generally shown in regard to graph 600D, the primary member 111 may define the first stiffness less than the secondary member 112 such that the slope 601 defines relatively greater deflection versus the change in load in contrast to the slope 602. In various embodiments, such as generally shown in regard to FIG. 1E, the static support structure 100 may further include a viscous material 115 within the gap 140 between one or more pairs of the plurality of members 110. In various embodiments, the viscous material 115 further defines a viscoelastic material. The viscous material 115 may further provide or improve damping of the static support structure 100, or a mechanical system 10 (e.g., FIGS. 8-10) to which the static support structure 100 is coupled. For example, the viscous material 115 may at least partially isolate vibration, dampen noise or resonance, or reduce shock due to loads, or changes in loads, or frequency of changes in loads, applied to the static support structure 100 or a surrounding mechanical system 10 (e.g., FIGS. 8-10). Various embodiments of the viscous material 115 may define a gel or foam applied at least partially within the gap 140 between one or more pairs of the plurality of members 110 (e.g., between the primary member 111 and an adjacent secondary member 112, or between adjacent pairs of secondary members 112, etc.). As another example, the static support structure 100 may further be defined within an enclosed cavity or vessel containing a viscous fluid, such that the viscous fluid may ingress to the gap 140 such as to define the viscous material 115. In various embodiments, the viscous material 115 defines a hydraulic fluid, a lubricant (e.g., oil, fuel, fuel-oil, etc.), amorphous polymers, semi-crystalline polymers, biopolymers, bitumen, non-Newtonian fluids, etc., or metals and/or liquids defining appropriate viscous properties.

Referring back to FIGS. 1-4, in one embodiment, the primary member 111 of the plurality of members 110 defines a nominal dimension. The one or more other members 110 defining the secondary member 112 defines one or more of a second dimension different from (e.g., less than or greater than) the nominal dimension of the primary member 111.

In one embodiment, such as generally provided in regard to FIGS. 1B-1H, the nominal dimension of the primary member 111 is extended along the lengthwise direction L to a maximum length. The secondary member 112 is extended along the lengthwise direction L to one or more of a second length less than or equal to the maximum length of the primary member 111.

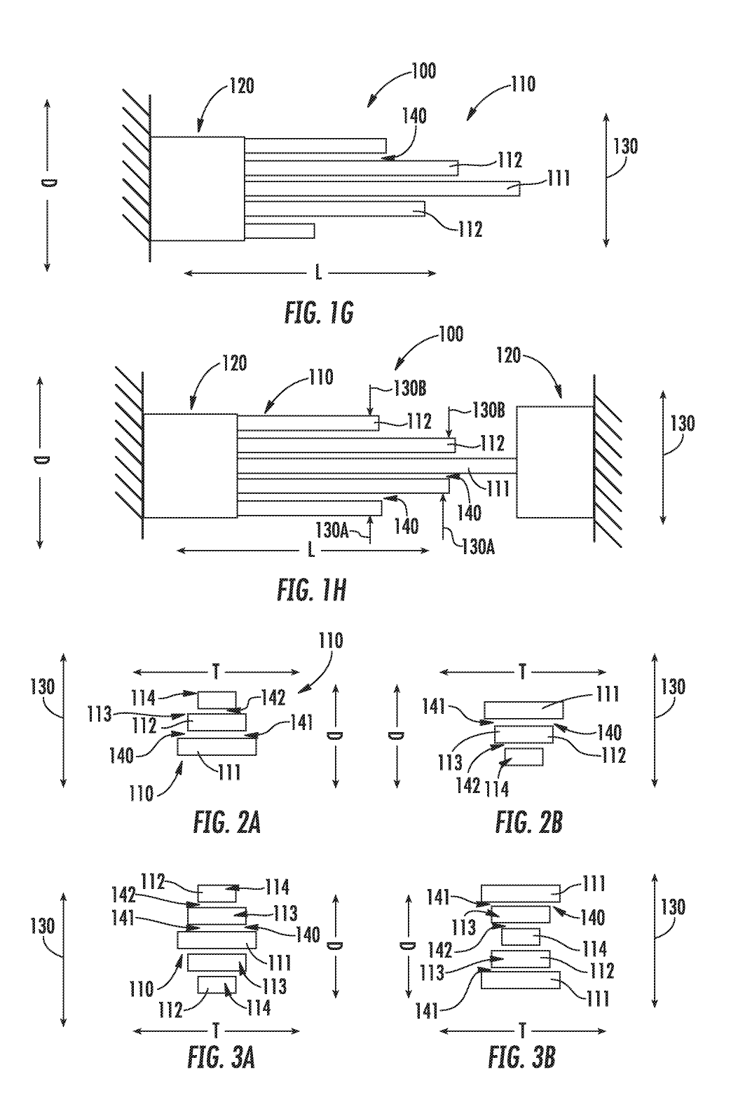

In another embodiment, such as generally provided in regard to FIGS. 2-3, the nominal dimension of the primary member 111 is extended along a transverse direction T to a maximum width. The secondary member 112 is extended along the transverse direction T to one or more of a second width less than the maximum width of the primary member 111.

In yet another embodiment, such as generally provided in regard to FIGS. 4A-4B and FIG. 6C, the nominal dimension of the primary member 111 is extended along the depth D to a maximum depth. The secondary member 112 is extended along the depth D to one or more of a second depth less than the maximum depth of the primary member 111.

In still another embodiment, such as generally provided in regard to FIG. 6D, the dimension of the secondary member 112 is extended along the depth D to a maximum depth. The primary member 111 is extended along the depth D to nominal depth less than the maximum depth of the secondary member 112. As such, the secondary member 112 may define a dimension greater than the nominal dimension of the primary member 111.

In various embodiments, such as generally shown in regard to FIGS. 2A-2B and 3A-3B, the plurality of members 110 may define substantially rectangular cross sectional areas. In other embodiments, such as generally shown in regard to FIG. 4B, one or more of the plurality of members 110 may define a substantially circular, ovular, elliptical, or crescent cross sectional area. In still various embodiments, the gap 140 between pairs of the plurality of members 110 may define a variable cross sectional area or distance along the traverse direction T and/or depth D, such as described above.

Referring back to FIGS. 2A-2B, various embodiments of the plurality of members 110 of the static support structure 100 may be defined in a uni-nonlinear arrangement, such as described in regard to FIG. 6B. For example, the plurality of members 110 may be arranged in descending dimensional order along the depth D of the static support structure 100. More specifically, the plurality of members 110 may be arranged in descending stiffness or cross sectional area along the depth D. For example, an outside-most or an inside-most member 110 may define the primary member 111. The secondary member 112 of a first secondary member stiffness defined less than the maximum stiffness of the primary member 111, such as shown at member 113, is disposed directly adjacent to the primary member 111. The secondary member 112 of a second secondary member stiffness defined less than the first secondary member stiffness, such as shown at member 114, is disposed directly adjacent to the secondary member 113 defining the first secondary member stiffness. As such, a load applied from a first direction (e.g., directly onto the primary member 111) may define a first load versus deflection non-linear curve of the static support structure 100 different from a second load versus deflection non-linear curve of a load applied from a second direction (e.g., directly onto the secondary member 112).

Referring now to FIGS. 3A-3B, various embodiments of the plurality of members 110 of the static support structure 100 may be define in a bi-nonlinear arrangement, such as described in regard to FIG. 6A. For example, referring to FIG. 3A, the plurality of members 110 may be arranged in which the primary member 111 is surrounded along the depth D. As another example, referring to FIG. 3B, the plurality of members 110 may be arranged in which the secondary member 112 is disposed between a pair or more of primary members 111 along the depth D. In one embodiment, such as shown in regard to FIG. 3B, the plurality of secondary member 112 is defined between a pair of primary members 111 disposed outside along the depth D of the secondary members 112. In another embodiment, the secondary member 112 defines the first stiffness secondary member 113 adjacent to the primary member 111. The secondary member 112 defining the second stiffness secondary member 114 is defined adjacent to or between the first stiffness secondary member 113 along the depth D.

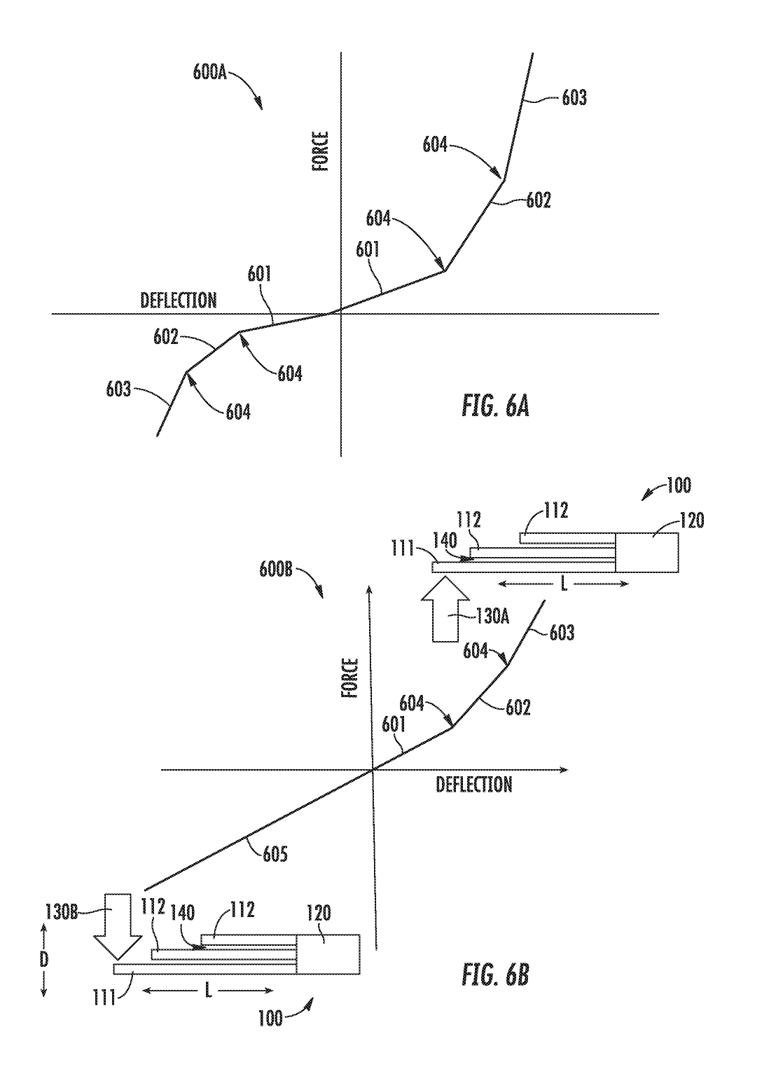

Referring now to FIG. 5, the static support structure 100 may define a radial nonlinear arrangement of the plurality of members 110. The plurality of members 110 are defined in generally concentric arrangement relative to a centerline axis 12. In one embodiment, the plurality of members 110 in concentric arrangement may further be defined in uni-nonlinear arrangement, such as shown and described in regard to FIGS. 2A-2B. In another embodiment, the plurality of members 110 in concentric arrangement may further be defined in bi-nonlinear arrangement, such as shown and described in regard to FIGS. 3A-3B.

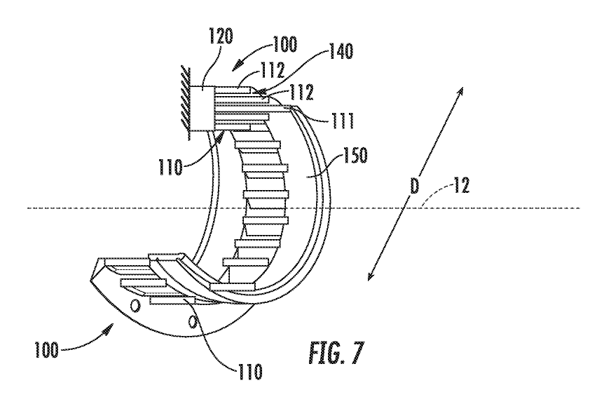

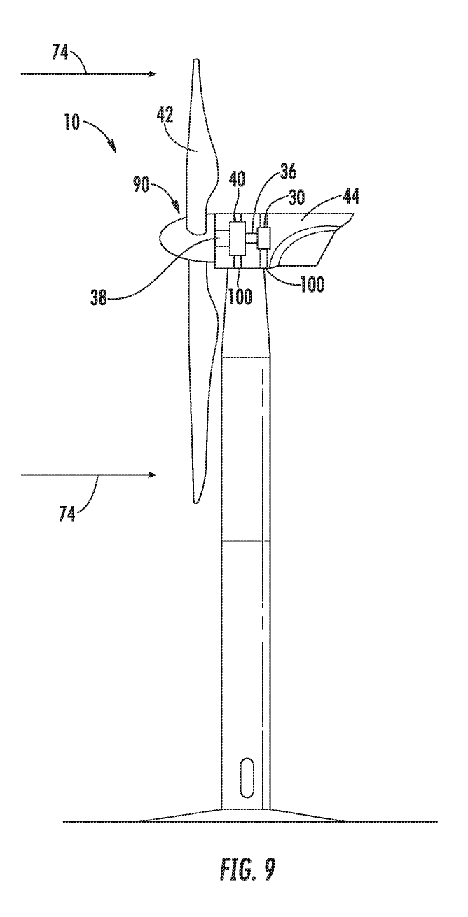

Referring now to FIG. 7, an exemplary embodiment of a static support structure 100 including the plurality of members 110 is generally provided. The exemplary embodiment generally provided further includes a load member 150 coupled to one or more of the plurality of members 110. The load member 150 may generally be coupled to at least the primary member 111 of the plurality of members 110. The load member 150 may generally define a surface at which a mechanical or thermal load is substantially applied to the static support structure 100 such as to enable deflection of one or more of the plurality of members 110 onto one another. For example, the load member 150 may generally define a bearing interface at which a centrifugal or thermal load from a rotor assembly 90 (FIGS. 8-9) may be applied to the static support structure 100.

Various embodiments of the static support structure 100 may be included in a mechanical system 10 such as generally provided in regard to FIGS. 8-9. In various embodiments, the static support structure 100 may generally define a casing or static support for a rotary structure. In another embodiment, the static support structure 100 may define a static support for a bearing assembly.

Referring now to FIGS. 8-9 in conjunction with FIG. 7, the mechanical system 10 may generally define any load-bearing system, such as, but not limited to, flexible couplings, fixed structures, trusses, pylons, rods, struts, beams, frames, casings, or mounts. For example, referring now to FIG. 8, a schematic partially cross-sectioned side view of an exemplary mechanical system 10 defining a gas turbine engine as may incorporate various embodiments of the present disclosure is generally provided. Although further described herein as a turbofan engine, the mechanical system 10 defining a gas turbine engine may define a turboshaft, turboprop, or turbojet gas turbine engine, including marine and industrial engines and auxiliary power units, or steam turbine engine. In further embodiments, the mechanical system 10 may further define, at least in part, a ground, sea, or air-based vehicle system. In still various embodiments, the mechanical system 10 may further define any suitable system including static structural supports.

As shown in FIG. 8, the mechanical system 10 has a longitudinal or axial centerline axis 12 that extends therethrough for reference purposes. An axial direction A is extended co-directional to the axial centerline axis 12 for reference. The mechanical system 10 further defines an upstream end 99 and a downstream end 98 for reference. In general, the mechanical system 10 may include a fan assembly 14 and a core engine 16 disposed downstream from the fan assembly 14.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 via a reduction gear assembly 40 such as in an indirect-drive or geared-drive configuration. Various embodiments of the reduction gear assembly 40 may define, but are not limited to, a planetary gear assembly, a star gear assembly, etc., or various compound gear assemblies, or any other suitable gear assembly.

As shown in FIG. 8, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. It should be appreciated by those of ordinary skill in the art that the nacelle 44 may be configured to be supported relative to the core engine 16 by a plurality of circumferentially-spaced outlet guide vanes or struts. Moreover, at least a portion of the nacelle 44 may extend over an outer portion of the core engine 16 so as to define a bypass airflow passage 48 therebetween.

It should be appreciated that combinations of the shaft 34, 36, the compressors 22, 24, and the turbines 28, 30 define a rotor assembly 90 of the mechanical system 10. For example, the HP shaft 34, HP compressor 24, and HP turbine 28 may define an HP rotor assembly of the mechanical system 10. Similarly, combinations of the LP shaft 36, LP compressor 22, and LP turbine 30 may define an LP rotor assembly of the mechanical system 10. Various embodiments of the mechanical system 10 may further include the fan shaft 38 and fan blades 42 as portions of the LP rotor assembly. In other embodiments, the mechanical system 10 may further define a fan rotor assembly at least partially mechanically de-coupled from the LP spool via the fan shaft 38 and the reduction gear assembly 40. Still further embodiments may further define one or more intermediate rotor assemblies defined by an intermediate pressure compressor, an intermediate pressure shaft, and an intermediate pressure turbine disposed between the LP rotor assembly and the HP rotor assembly (relative to serial aerodynamic flow arrangement).

During operation of the mechanical system 10, a flow of air, shown schematically by arrows 74, enters an inlet 76 of the mechanical system 10 defined by the fan case or nacelle 44. A portion of air, shown schematically by arrows 80, enters the core engine 16 through a core inlet 20 defined at least partially via the outer casing 18. The flow of air 80 is increasingly compressed as it flows across successive stages of the compressors 22, 24, such as shown schematically by arrows 82. The compressed air 82 enters the combustion section 26 and mixes with a liquid or gaseous fuel and is ignited to produce combustion gases 86. The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 entering the engine bypasses the core engine 16 and flows across the bypass airflow passage 48, such as shown schematically by arrows 78.

Referring to FIG. 9, an exemplary embodiment of the mechanical system 10 defining a wind turbine is generally provided. The mechanical system 10 defining a wind turbine may include a wind turbine blade or fan assembly 14 and nacelle 44. The nacelle 44 may further contain or house power generation and control components therewithin. The wind turbine blade or fan assembly 14 includes a plurality of blades 42 coupled to a turbine or fan shaft 38. The turbine or fan shaft 38 may further be coupled to a reduction gear assembly 40. The reduction gear assembly 40 is further coupled to a turbine 30 via the rotor shaft 36. The turbine 30 may further be coupled to or be a component of the power generation components within the nacelle 44. A flow of air 74 passes across the plurality of blades 42 to drive rotation of the wind turbine blade or fan assembly 14. The reduction gear assembly 40 translates the relatively slower rotational speed of the plurality of blades 42 to a relatively quicker rotational speed at the turbine 30 to generate power.

Operation of the mechanical system 10 may encounter undesired loading conditions or vibratory modes due to e.g., unbalances in the rotor assembly 90, resonance modes encountered across various rotational speed ranges of the rotor assembly 90, undesired structural failure or component liberation, domestic or foreign object damage, undesired combustion dynamics, engine stalls or surges, unsteady flows, or wind gusts or cross winds. Other undesired vibratory or loading conditions may result from eccentricities in the rotor assembly 90 relative to a surrounding casing, which in various embodiments includes the static support structure 100 defined around the rotor assembly 90. Such eccentricities may result from circumferential and/or radial thermal asymmetry at the rotor assembly 90 relative to a surrounding casing, causing the rotor assembly 90 to rotate eccentric to the surrounding casing relative to the axial centerline 12 (e.g., a bowed rotor condition).

As such, the static support structure 100 may be disposed throughout the mechanical system 10 to provide variable stiffness structures operable to a plurality of load versus deflection slopes, such as shown and described in regard to FIG. 6. For example, the static support structure 100 may at least partially define one or more casings surrounding the fan assembly 14 (e.g., the nacelle 44), the compressors 22, 24, the turbines 28, 30 (e.g., the outer casing 18), or bearing assemblies, such as including one or more bearing elements 160 disposed between the rotor assembly 90 and the static support structure 100. Still various embodiments may at least partially define the static support structure 100 as a shaft, such as, but not limited to, fan shaft 38, LP shaft 34, or HP shaft 36 (FIG. 8). Still further, although not shown in further detail, the static support structure 100 may further at least partially a mount, truss, frame, or tower supporting the mechanical system 10. For example, the static support structure 100 may couple the mechanical system 10 defining a turbine engine (e.g., FIGS. 8-9) to a vehicle, such as an aircraft or ground-based vehicle, or to a fixed structure, such as a power generation system.

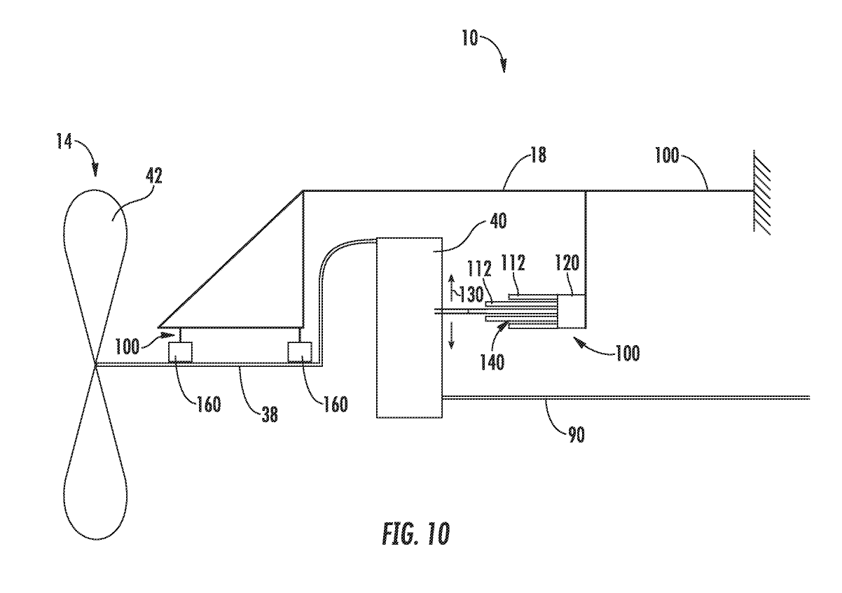

Referring now to FIG. 10, an exemplary schematic view of a portion of a mechanical system 10, such as generally shown and described in regard to FIGS. 8-9, is generally provided. The schematic view provides exemplary embodiments of placement of the static support structure 100 within the mechanical system 10. For example, the static support structure 100 may more specifically define a support structure for a reduction gear assembly 40. The static support structure 100 may generally provide nonlinear support stiffness such as described in regard to FIGS. 1-9 herein. For example, loads, and changes in loads or frequencies thereof, such as from the rotor assembly 90 to the fan assembly 14 through the reduction gear assembly 40 (e.g., such as in regard to a geared gas turbine engine), enable the static support structure 100 to provide nonlinear changes in deflection such as described herein. As another example, loads, and changes in loads or frequencies thereof, such as from the fan assembly 14 to the rotor assembly 90 through the reduction gear assembly 40 (e.g., such as in regard to a wind turbine), enable the static support structure 100 to provide nonlinear changes in deflection such as described herein.

Referring still to FIG. 10, the static support structure 100 may further be coupled to one or more bearing elements 160 or casings (e.g., outer casing 18, nacelle 44, etc.), such as to provide nonlinear changes in deflection relative to loads applied to the static support structure 100.

Various embodiments of the static support structure 100 shown and described herein may be formed by manufacturing methods such as, but not limited to, additive manufacturing or 3D printing methods, castings, forgings, or combinations thereof. Other embodiments may form the static support structure 100 via one or more machining methods or bonding methods, such as, but not limited to, welding, brazing, adhesive bonding, friction bonding, etc. Materials may include one or more materials appropriate for load-bearing static structures, such as, but not limited to, materials defining an elastic limit enabling elastic deformation of the plurality of members 110 onto one another. For example, the elastic limit of the material of one or more of the plurality of members 110 may be suitable to enable deflection of the member 110 along the load direction 130 at least corresponding to the distance of the gap 140.

Still various embodiments of the static support structure 100 shown and described herein may include a plurality of materials defining a plurality of stiffnesses and/or elastic limits. For example, the primary member 111 may define a first material and one or more of the secondary members 112 may define one or more of another material, varyingly similar and/or different from the first material. As another example, the secondary member 112 may define dimensions substantially equal to the primary member 111 while defining a stiffness less than or greater than the initial stiffness of the primary member 111, such as via different dimensions along the lengthwise direction L, the traverse direction T, the depth D, or combinations thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A static support structure, the static support structure comprising:
two or more members extended along a lengthwise direction coupled to a support body, wherein each of the plurality of members is disposed in adjacent arrangement along a load direction, and wherein each adjacent pair of members of the plurality of members defines a gap therebetween, and further wherein the plurality of members provides a nonlinear force versus deflection of the static support structure.

2. The static support structure of claim 1, wherein at least one member of the plurality of members defines a primary member defining an initial stiffness, and further wherein at least one member of the plurality of members defines one or more secondary stiffnesses less than or greater than the initial stiffness.

3. The static support structure of claim 1, wherein at least one member of the plurality of members comprises a primary member comprising a nominal dimension, and wherein the at least one member of the plurality of members comprises one or more secondary members comprising one or more secondary dimensions different from the nominal dimension.

4. The static support structure of claim 3, wherein the nominal dimension is defined along a depth, wherein the depth corresponds to the load direction.

5. The static support structure of claim 1, wherein the plurality of members comprise a uni-nonlinear arrangement.

6. The static support structure of claim 5, wherein the plurality of members are disposed in adjacent arrangement in descending dimensional order along a depth of the static support structure.

7. The static support structure of claim 5, wherein the plurality of members are disposed in asymmetric arrangement along a depth of the static support structure.

8. The static support structure of claim 1, wherein the plurality of members comprises a bi-nonlinear arrangement.

9. The static support structure of claim 8, wherein one or more of a secondary member is disposed between a pair or more of primary members along a depth of the static support structure.

10. The static support structure of claim 8, wherein one or more of a primary member is disposed between a pair or more of secondary members along a depth of the static support structure.

11. The static support structure of claim 1, wherein the plurality of members each extend at least partially circumferentially around an axial centerline axis, and wherein the plurality of members are each disposed in radial arrangement from the axial centerline axis.

12. The static support structure of claim 1, further comprising:
a viscous material disposed at least partially within the gap defined between a pair of the plurality of members.

13. The static support structure of claim 1, wherein the gap comprises a substantially constant cross sectional area along the lengthwise direction, a traverse direction, a depth, or combinations thereof.

14. The static support structure of claim 1, wherein the gap comprises a substantially variable cross sectional area along the lengthwise direction, a traverse direction, a depth, or combinations thereof.

15. A mechanical system, the system comprising:
a static support structure comprising a plurality of members extended along a lengthwise direction coupled to a support body, wherein each of the plurality of members is disposed in an adjacent arrangement along a load direction, and wherein each adjacent pair of members of the plurality of members defines a gap therebetween, and further wherein the plurality of members provides a nonlinear force versus deflection of the static support structure

16. The system of claim 15, wherein an at least one member of the plurality of members comprises a primary member comprising an initial stiffness, and further wherein the at least one member of the plurality of members comprises a secondary member comprising one or more secondary stiffnesses less than or greater than the initial stiffness.

17. The system of claim 15, wherein the static support structure further comprises:
a load member coupled to one or more of the plurality of members of the static support structure.

18. The system of claim 15, wherein at least one member of the plurality of members of the static support structure comprises a primary member comprising a nominal dimension, and wherein at least one member of the plurality of members comprises one or more secondary members comprising a secondary dimension different than the nominal dimension.

19. The system of claim 15, wherein the static support structure at least partially defines a bearing assembly, a gear assembly, or a casing.

20. The system of claim 15, wherein the system defines a turbine engine.
